(19) United States
(12) Patent Application Publication
(10) Pub. No.: US 2026/0104206 A1
(43) Pub. Date: Apr. 16, 2026

(54) EFFICIENT INDUCTION HEATING TUBE FURNACE

(71) Applicant: UNIVERSITY OF FLORIDA RESEARCH FOUNDATION, INCORPORATED, Gainesville, FL (US)

(72) Inventors: Charles J. HAGES, Gainesville, FL (US); Ruiquan YANG, Gainesville, FL (US); Alexander D. JESS, Gainesville, FL (US); Calvin FAI, Gainesville, FL (US)

(21) Appl. No.: 19/206,470

(22) Filed: May 13, 2025

Related U.S. Application Data
(60) Provisional application No. 63/646,067, filed on May 13, 2024.

(51) Int. Cl. F27D 11/06; F27D 5/00

(52) U.S. Cl. CPC F27D 11/06; F27D 5/0068

(57) ABSTRACT

An induction tube furnace system. The furnace includes a sealed quartz tube and a source of alternating current. A continuous unidirectional helical coil encircles the quartz tube and is responsive to the alternating current for generating an electromagnetic field within the quartz tube. A graphite vessel is disposed within the quartz tube. A processor controls the source of alternating current to achieve a desired temperature within the crucible or within the quartz tube. A target object within the vessel is heated by conduction or convection.

### CROSS REFERENCE TO RELATED APPLICATIONS

The present application claims priority under 35 U.S. C. 119(e) to the provisional patent application filed on May 13, 2024 and assigned application number 63/646,067. The provisional application is incorporated herein its entirety.

### GOVERNMENT SUPPORT CLAUSE

This invention was made with government support under Grant No. 2044859 awarded The National Science Foundation. The government has certain rights in the invention.

### BACKGROUND

An induction heater for heating a target object (also referred to herein as a target or a sample) comprises an induction coil and an electronic oscillator that supplies a high-frequency alternating current (AC) to the coil, thereby generating an electromagnetic field. The rapidly alternating magnetic field penetrates a proximate resistive/conductive target object, thereby generating electric currents inside the object. These currents are commonly referred to as eddy currents. The eddy currents flow through the resistive target object material and heat it by Joule heating. The frequency of the electric current used for induction heating depends on the target object size, material type, coupling (between the coil and the object to be heated), and the penetration depth of the magnetic field.

Induction heating devices are used in a wide variety of applications including, for example, heating beverage containers and industrial heating of various materials. Induction heating devices are also commonly used in research laboratories. One benefit of induction heating devices is the heat source, typically an induction coil, does not get hot, but instead the induction coil generates an electromagnetic field that heats the target object.

Such induction heating systems are also generally considered to be safer than traditional conduction, convection, or radiation heating systems. An induction heating device does not require an arc as in an electric arc furnace or combustion as in a blast furnace.

Tube furnaces are commonly employed in research facilities. Classic tube furnaces are heated with resistive wires that radiatively heat the interior of the tube furnace. The wires are made from materials such as Nichrome, Kanthal, or stainless steel. The entire chamber space within the tube furnace is heated to a predetermined value, and the temperature is controlled using PID (proportional-integral-derivative) algorithms.

Disadvantageously, heating the entire tube chamber space requires significant energy and since only a small region of the chamber is typically used, a significant amount of energy is wasted.

Thermocouples (often K-type) are typically used to measure temperatures at the location of the sample, frequently without a ceramic sheath. Using K-type thermocouples without a protective sheath may cause preferential oxidation in reduced environments, leading to incorrect readings and potential safety risks.

In cases where a ceramic sheath is used, the presence of a bulky material between the furnace chamber and the thermocouple measuring tip may result in a temperature offset between the actual temperature of the sample and the measured temperature. Thus, additional calibration efforts are necessary.

Additionally, once purchased, the chamber size (related to the maximum tube size that can fit within the chamber) is fixed and cannot be adjusted as needed by the user for other applications.

Since the furnace is sealed after heating, direct observation of the sample status during the heating process is not feasible. A conventional tube furnace allows monitoring of temperature and pressure only during operation and cannot be accessed later.

### BRIEF DESCRIPTION OF THE DRAWINGS

The present embodiments are illustrated by way of example, and not by way of limitation, in the figures of the accompanying drawings.

The following figures are illustrative only, and are not intended to be limiting.

FIG. 1 shows details of an induction-heating tube furnace of the present invention.

FIG. 2 shows a thermocouple for use with the tube furnace of FIG. 1.

FIG. 3 shows a block diagram depicting several components of the tube furnace of FIG. 1 as controlled by a computer, i.e., a “PC.”

### DETAILED DESCRIPTION

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described. All publications mentioned herein are incorporated herein by reference.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about”or “approximately”refers is itself also specifically, and preferably, disclosed.

Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art of this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination

The terms electromagnetically coupled, inductively coupled, and non-contact heating tend to be used interchangeably throughout this disclosure and generally have the same meaning. The terms heating element, interior vessel or reactor wall, magnetic material, magnetic heating element, and high μ material also tend to be used interchangeably in this disclosure and generally have the same meaning. Similarly, the terms heat source, and AC excitation magnet, and coil tend to be used interchangeably throughout this disclosure and generally have the same meaning. The terms container, vessel, and reactor generally have the same meaning and tend to used interchangeably throughout this disclosure.

As used herein, the terms the AC power source, heat source, and heating element generally have different meanings. The AC power source delivers AC power from an electricity source to the AC excitation element or inductive coil. The term heat source refers to the wire or induction coil that generates the electromagnetic field. The term heating element refers to a material exhibiting a high magnetic permeability μ (mu) that is magnetically or inductively coupled to the heat source. It will be understood by one of ordinary skill in the art that when the heat source and the heating element are inductively-coupled they may or may not be in direct physical contact with each other.

The inventors have invented a tube furnace system that operates without a bulky heating chamber, instead, using an induction-heating apparatus to heat a target object disposed in a vessel within the tube furnace. The heating is achieved by exposing the vessel, which is preferably at least partially constructed of graphite to an electromagnetic field generated by an induction coil. The induction coil and the vessel (also referred to as a crucible) are therefore characterized as electromagnetically coupled. The vessel is advantageously constructed of graphite, which offers excellent electrical and thermal conductivity and is the only non-metal that effectively conducts electricity

Such tube furnaces typically function as a chemical reactor or process vessel in which a chemical reaction occurs. Specific design elements of these tube furnace are determined by details of the specific chemical reaction and the intended application.

According to the present invention, the electromagnetic field, as generated by the coil, impinges and penetrates the tube furnace, striking the graphite box. The field generates eddy currents within the magnetically conductive wall surfaces of the graphite box. As these currents flow within the resistive material of the wall surfaces, they generate heat. The target sample, in thermal communication with the graphite box wall surfaces (or with the quartz liner within the graphite box) is thereby conductively heated. Thus, AC excitation of the inductive coil heat source heats the target object with no direct connection between the heat source and the target object.

Susceptance (a measure of the ability of a material to pass an alternating (AC) signal) of the graphite box is relatively high, allowing the electromagnetic field to easily pass through and heat the walls and interior of the graphite box. The graphite box also exhibits good thermal conductivity, which is an important material property for heating the target object within the graphite box. The graphite box is also referred to herein as a graphite susceptor.

The heating process is rapid and advantageously can be accurately controlled (by controlling the DC input to the AC generator that in turn affects the electromagnetic field) to achieve a desired temperature within the graphite box. In one application, the temperature ramp rate (both increasing and decreasing) is accurately controlled by adjusting the DC power supplied to the AC generator, which in turn controls the energy of the electromagnetic field generated by the induction coil. The temperature range within the graphite box that houses the target sample is controllable between a customary room temperature of about 20- 22° C. and about 1200° C.

Coupling between the induction coil and the graphite box is critical to maximize the electromagnetic energy that impinges the graphite box. To ensure good coupling, it is possible to qualitatively determine the degree of coupling by measuring the rate at which the temperature within the tube furnace increases responsive to the electromagnetic energy. Of course, the spacing between the reactor vessel and the induction coil is directly related to the coupling between these two elements. The degree of coupling is indicated by the rate at which the temperature within the graphite box or of the target object increases.

The frequency of the ac signal also effects the electromagnetic coupling. The AC generator of the invention is tunable over a broad frequency range up to about 300 kHz. Thus, the frequency can be changed to improve the coupling between the inductor and the graphite box.

The energy consumed by the system of the present invention is notably less than prior art tube furnaces, which are also typically much larger in volume. In the tube furnace of the present invention only a small amount of material requires heating, that is, the material of the graphite box and in turn the target sample. Furthermore, the system can heat the graphite box carrying the target object significantly faster than a conventional tube furnace. This aspect is particularly important in research applications where accurate monitoring of reaction times at specific temperatures is required.

Temperature regulation is achieved through the use of a specially designed thermocouple that responds rapidly and accurately, to the high ramp rate of the heating process. Additionally, the thermocouple is insulated by a quartz tube to survive various environmental conditions that might be present within the tube furnace, including oxidizing and inert or reducing environments. The temperature can also be monitored using a pyrometer attached to the spare tube portal.

The pressure inside the tube is also carefully monitored (and controlled) via a digital pressure converter, which has a range of ±10⁵ atm for low vacuum and low positive pressure environments.

The tube furnace also includes a Pirani gauge for measuring pressure within the middle vacuum range from about 10⁻¹ to about 10⁵ Pa. The tube furnace pressure is controlled by opening/closing three solenoid pressure-relief valves.

All analog measured values (e.g., temperature and pressure) are converted to digital equivalents, when necessary, and then input to a computer (PC) for further processing. Employing a customized LabVIEW program and a PID control algorithm, all data is recorded and input to the computer for controlling the various system parameters, such as the temperature of the graphite box.

The graphite box that houses the target object can be configured in an opened or a closed condition. Advantageously, an open graphite box allows direct observation of target object status inside the box.

A closed graphite box with an internal quartz liner can be utilized for applications where it is necessary to maintain a specific vapor pressure inside the graphite box.

Additionally, the furnace tube can be easily replaced for different reaction scales by changing the tube, flanges, and graphite box accordingly.

The present tube furnace design offers several advantages over the prior art. The induction design enables rapid heating (and cooling) compared to traditional tube furnaces. This feature shortens processing times and therefore enables exploration of processing conditions not possible with traditional tube furnaces.

The sample space is customizable in that graphite reactor boxes, quartz tube sizes. and corresponding induction coils can be designed to fit the desired application. Additionally, these can be customized by simply changing out one or more of these elements for different applications. Due to the customizable design, one induction furnace constructed according to the teachings of the present invention can replace several traditional tube furnaces.

The temperature within or proximate the graphite reactor box is directly measured, whereas in a traditional furnace the temperature of the heating block outside the tube is measured. Direct temperature measurement is obviously preferred over an inferred temperature.

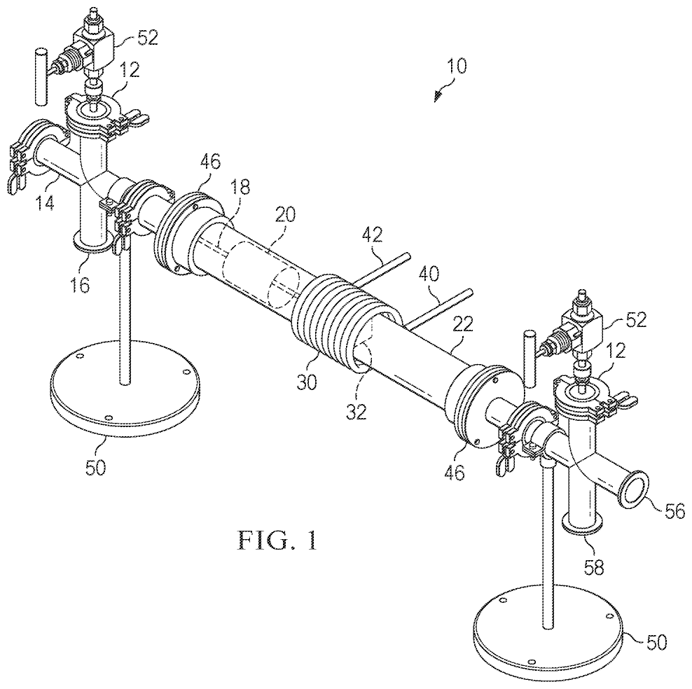

FIG. 1 illustrates principal components of the inductively-heated tube furnace 10:
A vacuum clamp 12 through which a vacuum is pulled within the tube furnace.
A KF cross 14
A portal 16 to a Pirani gauge (not shown) for measuring pressure within the tube furnace.
A thermocouple 18 for measuring temperature within the tube furnace.
A tube block 20

In one embodiment the tube furnace comprises a quartz tube 22.

A coil 30 generates the magnetic field that inductively heats a sample (not visible) within a graphite box 32 disposed within the quartz tube 22.

Two coil leads 40 and 42 are connected to a power supply (not shown) for providing the AC alternating current to the coil 30.

The graphite box 32 is disposed within the coil 30 and encloses the sample.

Flanges 46 support the elements of the tube furnace 10 as attached to support stands 50. The support stands are disposed at each end of the tube furnace 10 for supporting the furnace at a desired height above a surface.

Needle valves 52 for controlling pressure within the quartz tube or the flow rate of gas into or out from the quartz tube.

A portal 56 extends to a pyrometer (not visible in FIG. 1) for measuring the temperature within the tube furnace 10.

A portal 58 leads to pressure converter, not shown in FIG. 1.

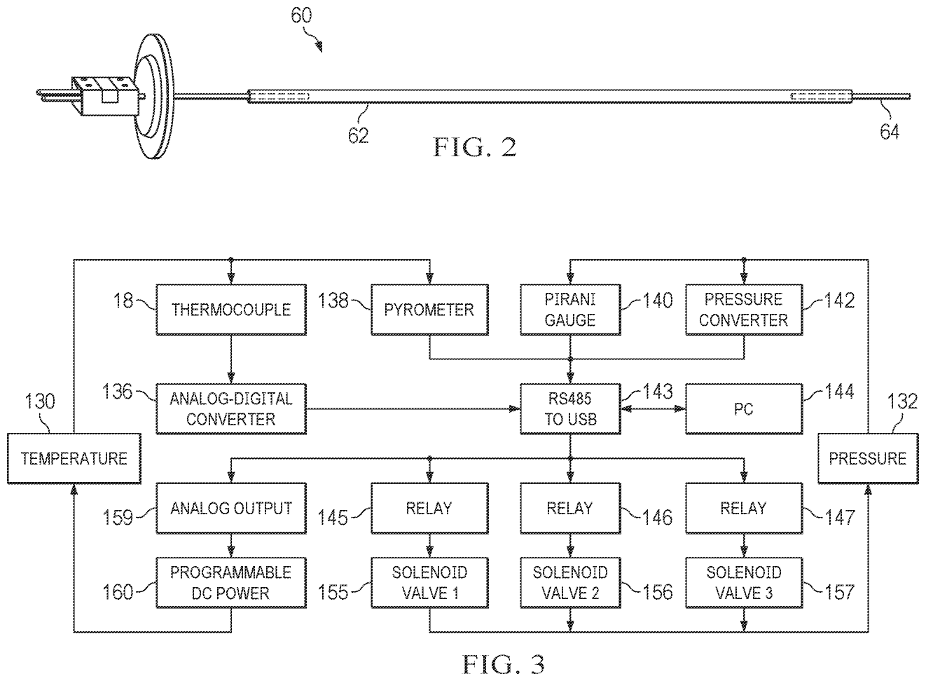

FIG. 2 illustrates a K-Type thermocouple 60, including a stainless steel sheath 62 that encircles the thermocouple leg 64.

FIG. 3 illustrates a block diagram of the control and operation components associated with the tube furnace of the invention.

A processor or “PC” 144 receives inputs related to the pressure and temperature as measured within or proximate the graphite box 32 of FIG. 1. These parameters are designated by a temperature block 130 (the temperature measured by a thermocouple 18 of FIG. 1) and a pressure block 132 (the pressure measured by a Pirani gauge). Responsive to these measured parameters, the PC 144 executes a PID (proportional/integral/derivative) algorithm for controlling the electromagnetic field and thus the temperature of the target object within the graphite box 32 of FIG. 1.

Temperatures are measured by the thermocouple 18 of FIGS. 1 and 2 (and the analog output value converted to a digital value in an analog-to-digital converter 136). and measured by a pyrometer 138, which is accessed via the portal 56 of FIG. 1. Output values from the pyrometer 138 are in digital form and thus input to the PC 144 via an RS495 to USB converter 145.

On the pressure side, the Pirani gauge 140 (accessed via the portal 16 of FIG. 1) and/or a pressure converter 142 (accessed via the portal 58 of FIG. 1) measure pressure values within the graphite box or proximate the graphite box of FIG. 1.

The pressure and temperature values are input to the PC 144 via the RS495 to USB converter 145. Outputs from the PC 144 control relays 145, 146, and 147 for respectively controlling (that is, opening and closing) solenoid valves 155, 156, and 157.

An analog output (indicated by a block 159) from the PC 144 (via the RS485 to USB converter 145) is input to a programmable DC power supply 160 (via the coil leads 40 and 42 in FIG. 1) for setting the frequency and voltage/power level of the current supplied to the induction coil 30 of FIG. 1, which in turn determines characteristics of the electromagnetic field (including especially the temperature) generated by the coil.

What is claimed is:

1. An induction tube furnace system, comprising/
a sealed quartz tube;
a source of alternating current;
a continuous unidirectional helical coil encircling the quartz tube responsive to the alternating current for generating an electromagnetic field within the quartz tube;
a vessel disposed within the quartz tube, a material of the vessel comprising a high susceptance material;
a processor for controlling the source of alternating current to achieve a desired temperature within the vessel or within the quartz tube; and
a target object within the vessel heated by conduction or convection from the vessel.

2. The induction tube furnace system of claim 1, wherein the processor controls a plurality of valves disposed within the quartz tube to control a pressure within the quartz tube.

3. The induction tube furnace system of claim 2, wherein the pressure within the quartz tube is controlled to between a high vacuum and atmospheric pressure.

4. The induction tube furnace system of claim 1, further comprising a thermocouple or a pyrometer to measure a temperature within the quartz tube.

5. The induction tube furnace system of claim 1, wherein a pyrometer measures the temperature within the quartz tube through a sapphire window within the quartz tube.

6. The induction tube furnace system of claim 1, wherein the source of alternating current comprises a power supply.

7. The induction tube furnace system of claim 6, wherein power supply is responsive to a direct current, wherein direct current controls a frequency of the alternating current.

8. The induction tube furnace system of claim 7, wherein a frequency of the alternating current is less than 300 kHz.

9. The induction tube furnace system of claim 1, wherein the processor executes a PID (proportional-integral-derivative) algorithm to control the temperature or pressure within the quartz tube.

10. The induction tube furnace system of claim 7, wherein the PID algorithm comprises a plurality of temperature profile settings.

11. The induction tube furnace system of claim 1, wherein the quartz tube is transparent.

12. The induction tube furnace system of claim 1, wherein a material of the vessel comprises graphite.

13. The induction tube furnace system of claim 1, wherein the vessel is configured in an opened or a closed state.

14. The induction tube furnace of claim 13, wherein the vessel is configured in a closed state for maintaining a specific vapor pressure inside the vessel.

15. The induction tube furnace of claim 1, further comprising a temperature measuring device within or proximate the vessel for directly measuring the temperature within the vessel.
